(19) United States
(12) Patent Application Publication
(10) Pub. No.: US 2010/0177247 A1
(43) Pub. Date: Jul. 15, 2010

(54) AMBIENT LIGHTING

(75) Inventors: Dragan Sekulovski, Eindhoven (NL); Ramon Antoine Wiro Clout, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/517,373

(22) PCT Filed: Dec. 3, 2007
(86) PCT No.: PCT/IB07/54884

§ 371 Date: Mar. 12, 2010

(30) Foreign Application Priority Data
Dec. 8, 2006 (EP) 06125690.5

(51) Int. Cl. H04N 5/58

(52) U.S. Cl. 348/602; 348/E05.12

(57) ABSTRACT

A system for facilitating accompanying an image or video rendering with a concurrent controlled ambient lighting, comprises a color selector (302) for selecting a color of the controlled ambient lighting in dependence on scene lighting information associated with the image or with at least one image of the video. An image analyzer (304) is provided for computing an illuminant parameter indicative of the scene lighting based on the image or video, wherein the color selector is arranged for selecting the color in dependence on the illuminant parameter.

### FIELD OF THE INVENTION

The invention relates to ambient lighting.

### BACKGROUND OF THE INVENTION

As an optional feature of a television, ambilight makes an impressive contribution to the overall viewing experience by producing ambient light to complement the colors and light intensity of the on-screen image. It adds a new dimension to the viewing experience, completely immersing the viewer into the content being watched. It creates ambiance, stimulates more relaxed viewing, and improves perceived picture detail, contrast, and color. Ambilight automatically and independently adapts its colors according to the changing content on the screen. In standby mode of the television, the lights can be set to any color to create a unique ambiance in the room.

### SUMMARY OF THE INVENTION

It would be advantageous to have an improved ambient lighting. To better address this concern, in a first aspect of the invention a system is presented for facilitating accompanying an image or video rendering with a concurrent controlled ambient lighting, comprising a color selector for selecting a color of the controlled ambient lighting in dependence on scene lighting information associated with the image or with at least one image of the video.

This allows to transform the lighting in an image into ambient lighting in the room of the viewer. Lighting is a main atmosphere creator, both in the image or video, and in the room of the viewer. Selecting the color of the ambient lighting in dependence on the lighting information associated with the image helps to better convey the atmosphere of the image or video into the room of the viewer. This results in a more natural ambient lighting color and a more immersive viewing experience. The ambient lighting color based on the scene lighting has highly desirable properties and provides a very immersive environment. Color, as a term used in color science, includes all the perceptual properties that light induces, including brightness, saturation, and hue. The system has the additional advantage that, as the scene lighting is a relatively stable and relatively slowly changing property, the ambient lighting color in dependence on scene lighting information is also relatively stable and relatively slowly changing. This holds for video as well as for series of images having similar lighting conditions.

By selecting an ambient lighting color in dependence on the scene lighting information, the atmosphere of the image or video can be re-created in the room of the viewer. For example the scene lighting color can be selected to be identical to a color indicated by the scene lighting information.

An embodiment comprises

an input for receiving the image or video;

an image analyzer for computing an illuminant parameter indicative of the scene lighting based on the image or video, wherein the color selector is arranged for selecting the color in dependence on the illuminant parameter.

With help of the image analyzer, the scene lighting information can be efficiently recovered without a need to know actual lighting conditions during the photography or camera shoot.

In an embodiment, the image analyzer is constructed for computing the illuminant parameter according to at least one of:

a gray world method;

a method of estimating a maximum of each color channel;

a gamut mapping method;

color by correlation; or

a neural network method.

These methods are known to compute an illuminant parameter of an image. A gray world method and a method of estimating a maximum of each color channel are examples of relatively computationally efficient methods, whereas a gamut mapping method, a color by correlation method, or a neural network method potentially provide relatively good results.

In an embodiment, the color selector is arranged for selecting a chroma and/or a hue of the controlled ambient lighting in dependence on the scene lighting information. Especially chroma and/or hue are important to create a particular atmosphere corresponding to the image/video rendering.

In an embodiment, the color selector is arranged for selecting a luminance of the controlled ambient lighting independently of the scene lighting information.

Even though all of chroma, hue, and luminance can be selected in dependence on the scene lighting, it is sometimes advantageous to select the luminance of the ambient lighting independently of the scene lighting information. For example, the luminance level may be fixed.

In an embodiment, the image analyzer is arranged for computing the illuminant parameter in real-time just before a rendering of the at least one image. In this case the ambient lighting can be controlled based on the lighting without any special requirements on the image or video supplied. Because the embodiment relies on computing the illuminant parameter just before a rendering of the at least one image, the illuminant parameter does not have to be stored by a television broadcaster or on a storage medium (e.g. DVD, VHS tape).

An embodiment comprises a metadata generator for including the selected color in metadata associated with the video or image. This allows the color selection to be performed earlier. There can be several reasons for doing this. For example, the computations can be performed off-line and stored for later usage, which requires less processing power than performing the computations in real-time. Also, it allows manual correction before rendering and it allows selected color information to be distributed by a content provider such as a broadcaster. The metadata may have any format, such as MPEG 7 or EXIF.

An embodiment comprises an input for receiving the scene lighting information. Because the scene lighting information is provided to the input, the color selector requires very little computational resources.

In an embodiment, the scene lighting information is indicative of physical lighting conditions of a scene captured in the at least one image. This allows using relatively accurate lighting information. For example, logged data from stage lighting equipment may be used, or information obtained from a light sensor used during the video recording or photography. Also, flashlight information (which may be stored in EXIF format) may be used.

In an embodiment, the scene lighting information is indicative of artificial computer graphics lighting conditions of an artificial computer graphics scene captured in the at least one image. This is a particularly efficient way to obtain accurate lighting information. It can be used in for example computer games. In computer graphics, the lighting conditions are fully controlled by the computer graphics software used. This is the case in for example animations made with help of computer graphics. Another application comprises a computer game enhanced with ambient lighting. For example, the computer graphics image or video may be generated using OpenGL. OpenGL provides an application programming interface to specify the shape and appearance of artificial objects (for example animation characters in an animation or image), as well as the location and characteristics of artificial light sources illuminating the artificial objects. The specification of the light sources can be used as lighting information.

In an embodiment, the input is arranged for receiving metadata associated with the video or image, the scene lighting information being incorporated in the metadata, and the input comprising a parser for extracting the scene lighting information from the metadata. Metadata is already commonly accompanying images and video data. Extracting the lighting information from the metadata is therefore easy to realize.

In an embodiment, the metadata comprises an illumination invariant color descriptor and the color selector is arranged for selecting the color in dependence on the illumination invariant color descriptor. An example of an illumination invariant color descriptor, known from the MPEG 7 standard, wraps the color descriptors in ISO/IEC 15938-3 that are dominant color, scalable color, color layout, and color structure. One or more color descriptors processed by the illumination invariant method can be included in this descriptor. This is efficient to realize, as the color selector does not need to process the whole image, and the illumination invariant color descriptor is already a standardized feature of the MPEG7 standard.

The system may comprise a light source controller for controlling an ambient light source to produce light having the selected color synchronously with a rendering of the image. The system may also comprise a display for rendering the image. The system may also comprise at least one ambient light source connected to the light source controller.

The ambient light source and the display may be comprised in distinct apparatuses. The improved, more stable color, selected in dependence on the scene lighting information, is even more apparent when using one or more light sources further away (for example more than 1, more than 2, or more than 3 meters) from the display. This is even more true if the light sources are distributed around the viewer. The same holds when there is a plurality of separate apparatuses comprising controlled sources all supporting the same content rendering.

An embodiment comprises an authoring tool for creating metadata facilitating accompanying an image or video rendering with a concurrent controlled ambient lighting, comprising

an input for receiving the image or video;

a color selector for selecting a color of the controlled ambient lighting in dependence on scene lighting information associated with the image or with at least one image of the video; and

a metadata generator for including an indication of the color in metadata associated with the image or video.

Incorporating the color selector in an authoring tool allows interesting features such as convenient manual correction and fine-tuning of the selected colors, as well as interactively identifying interesting regions for which the color has to be selected by the color selector.

An embodiment comprises a method of facilitating accompanying an image or video rendering with a concurrent controlled ambient lighting, comprising selecting a color of the controlled ambient lighting in dependence on scene lighting information associated with the image or with at least one image of the video.

An embodiment comprises a computer program product comprising instructions for causing a processor to perform the method set forth.

### BRIEF DESCRIPTION OF THE DRAWINGS

These and other aspects of the invention will be further elucidated and described with reference to the drawing, in which

FIG. 1 diagrammatically illustrates a room with a home entertainment system;

FIG. 2 illustrates a diagram of an embodiment; and

FIG. 3 illustrates a diagram of an embodiment.

### DETAILED DESCRIPTION OF EMBODIMENTS

Recent developments in ambient intelligent lighting allow for automatic content dependent light effects. An example of which is the ambilight TV. In the case of automatic light effects production from video content, existing solutions use the concept of dominant color of a region of video. Estimating the lighting in a scene is a problem which arises in many areas of computer vision like object recognition, background-foreground separation and image and video indexing and retrieval.

Algorithms for automatic light effect generation may use estimation of the dominant color of a region of the video. For example, this may be done in connection to the concept of Leaky TV, which aims to extend the color of the boundary of the video, providing the effect of colors “leaking” from the TV onto the wall. The dominant color has some undesirable properties. This is especially true for light units other than the ones mounted behind the TV. Such light units are referred to herein as ‘light speakers’. One of the problems of the dominant color is that small global changes in the scene can produce large changes in the produced light effects. Such large changes may be undesirable, in particular for light units that produce light at higher power levels and define a major part of the overall illumination of the environment. The changes of the produced light effects can be controlled and reduced in later stages of the automatic light effects generation. However, it is preferred to directly estimate the light effect from the images or video in a satisfactory way. The scene lighting is usually much more stable and changing more slowly than the dominant color. This also applies to individual still images, for example when rendering a series of images taken under similar lighting conditions. Further, scene lightning is one of the main atmosphere creators in video and still photography. Thus, estimating scene lighting and transferring it to the surrounding of the viewer can produce more desirable properties of the light effects as well as a more immersive environment. Also, when the images or video are the result of home photography or home video, the ambient light enhances the possibilities to review memories, re-live moments, and to re-create the same atmosphere.

The scene lighting information, which can be recorded and given as part of the media stream, or estimated from the image or video, can be used for automatic generation of light effects synchronized with the media or generation of light scripts. Current work permits for on line and off line estimation of the lighting. The estimation can be based on the information of the whole video frame (image) or of regions of the video frame (image) and the result can be mapped to a single light unit or to a plurality of light units.

The image recorded by a camera depends on three factors: the physical content of the scene, the illumination incident on the scene, and the characteristics of the camera. The goal of computational color constancy is to account for the effect of the illuminant, either by directly mapping the image to a standardized illuminant invariant representation, or by determining a description of the illuminant which can be used for subsequent color correction of the image. This has important applications such as object recognition and scene understanding, as well as image reproduction and digital photography. Another goal of computational color constancy is to find a nontrivial illuminant invariant description of a scene from an image taken under unknown lighting conditions. This is often broken into two steps. The first step is to estimate illuminant parameters, and then a second step uses those parameters to compute illumination independent surface descriptors. It is the first step that is used for the purpose of ambient lighting and scene lighting re-creation in embodiments described herein.

“A comparison of computational color constancy algorithms—Part I: Methodology and experiments with synthesized data” and “Part II: Experiments with Image Data”, by K. Barnard et al., in: IEEE Trans. Im. Proc., Vol. 11, No. 9, 2002, collectively referred to hereinafter as “Barnard”, describes and compares a number of color constancy algorithms, including gray world methods, illuminant estimation by the maximum of each channel, gamut mapping methods, color by correlation, and neural net methods. In those algorithms, the illuminant parameter is used to compute illumination independent surface descriptors. For example, the illumination invariant description can be specified as an image of the scene as if it were taken under a known, standard, canonical, light. Often, a diagonal model of illumination change can be assumed. Under this assumption, the image taken under one illuminant may be mapped to another illuminant by scaling each channel independently. The scaling is performed in an appropriate color space, for example one of the color spaces defined by CIE (e.g. CIELAB). However, the scaling will be explained here for the special example of an RGB color space. Suppose that the camera response to the white patch under the unknown illuminant is (R^{U}, G^{U}, B^{U}), and that the response under the known, canonical illuminant is (R^{C}, G^{C}, B^{C}). Then the response to the white patch can be mapped from the unknown case to the canonical case by scaling the three channels by R^{C}/R^{U}, G^{C}/G^{U}, and B^{C}/B^{U}, respectively. To the extent that this same scaling works for the other, nonwhite patches, it is said that the diagonal model holds. If the diagonal model leads to large errors, then performance may be improved by using, for example, sensor sharpening.

An embodiment comprises a home entertainment system in which video content is played synchronized with a reconstruction of the scene lighting using the available light units. The scene lighting for given spatial regions is estimated by means of real time algorithms, for example one of the color constancy algorithms described in Barnard, such as gray world methods, illuminant estimation by the maximum of each channel, gamut mapping methods, color by correlation, and neural net methods. Alternatively, the scene lighting for given spatial regions is pre-computed by a content provider and included in metadata accompanying the video content. The metadata is processed by the home entertainment system and the light effects described therein are actuated synchronized with the video rendering. In another alternative, the scene lighting for given spatial regions is derived from the metadata part of the media, for example Mpeg 7 descriptor. For example, the metadata may comprise information about actual lighting conditions during the video recordings.

After estimation of the scene lighting, the estimation is mapped to the available light units. This step may be based on lighting conditions in different regions of the screen or scene. Alternatively, it is based on information in the metadata. For example, the metadata may prescribe a light effect for each light speaker. Also, the estimated scene lighting, given as a color in the content color space, is transferred to the color space of the light units. This optional step may be performed on-line by the home entertainment system. Finally, the color corrected light effects are rendered synchronized to the content.

The methods described herein can be used in applications in which the light effects are generated automatically or semi automatically. The methods may also be applied for automatic or semi-automatic generation of offline scripts for light effect generation or for providing a tool for an ambient script writer, like in amBX.

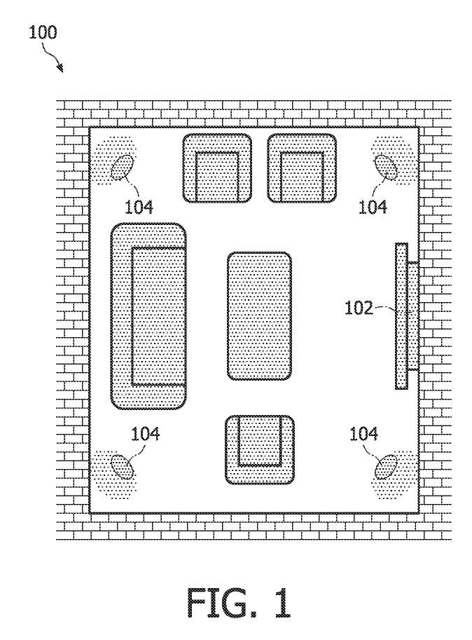

FIG. 1 illustrates a living room 100 including elements of a home entertainment system. The home entertainment system comprises a display 102 and light sources 104. The display 102 has an optional ambilight comprising one or more controlled light sources illuminating the space and wall behind the display 102. The ambilight is a controlled light source. The home entertainment system shown in FIG. 1 also comprises light speakers 104. Such light speakers are controlled light sources in apparatuses separate of the display. In the Figure, each light source illuminates a corner of the room.

The colors of the controlled light sources are controlled in dependence on the renderings on the display. For example, the scene lighting of a rendered scene is determined and this information is used to control the light sources. The different light sources may be controlled differently, based on information relating to different aspects of the rendering. For example, the display may be divided into regions, each region corresponding to a light source. The scene lighting information relating to each region is used to control each corresponding light source. It is also possible that all the light sources produce the same color to create a homogeneous ambient lighting.

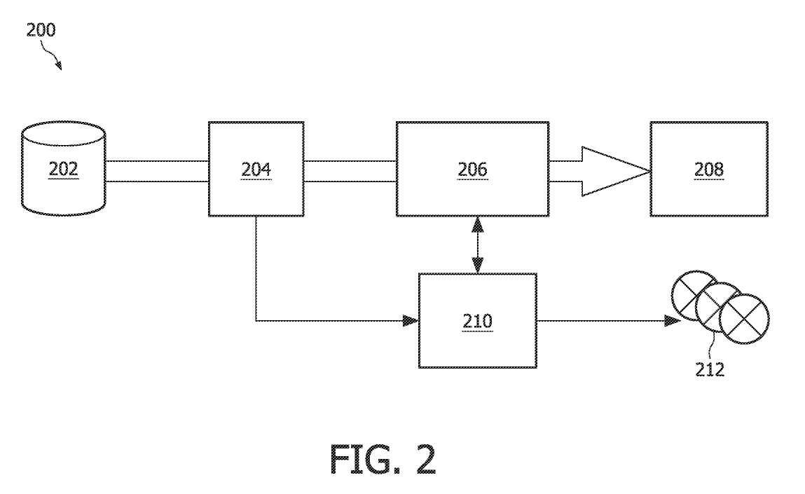

FIG. 2 illustrates an embodiment of the invention. In general, video content needs to be analyzed before it is rendered on the screen. This content analysis extracts several features, which are used to calculate the colors and intensities for the light units in the room. These values are then sent to the light units synchronously with the content on the display. Content 202 is sent to content analyzer 204. The content features resulting from the content analyzer 204 are sent to color/intensity selector 210. The selected color and/or intensity is used to control light units 212. Color selector 210 communicates with synchronizer 206 for ensuring that the light effects are synchronized with the content rendering on display 208.

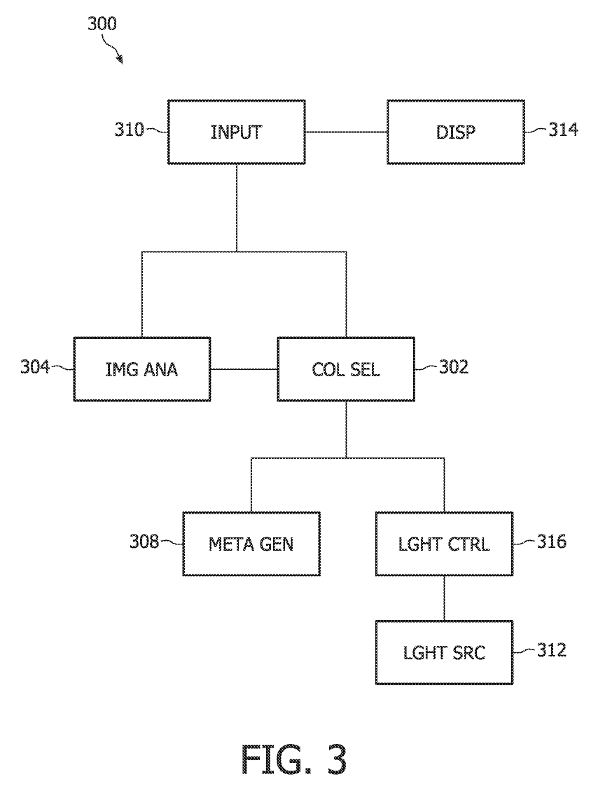

FIG. 3 illustrates aspects of several embodiments of the invention. It shows a system 300 facilitating accompanying an image or video rendering with concurrent controlled ambient lighting. The system comprises a color selector 302 for selecting a color of the controlled ambient lighting. To this end, it receives scene lighting information associated with the image or with at least one image of the video. This information may originate from input 310 and/or from image analyzer 304.

In an embodiment, the image or video is received by input 310 and provided to image analyzer 304. The image analyzer analyzes at least a region of at least one image at a time. The image analyzer 304 computes an illuminant parameter of the region of the image. This illuminant parameter is sent to color selector 302. Several illuminant parameters (e.g. color coordinates, brightness, values for different regions of the image) may be computed and sent to color selector 302.

The illuminant parameter is a concept that is often used in computational color constancy algorithms, as explained above. The illuminant parameter (in a simple example, the camera response to a white patch) is sent to the color selector 302, which selects a proper color to control a light source for generating an ambient lighting environment. The illuminant parameter comprises color information of an estimated illuminant. The lighting of the image is re-created by means of the controlled light source. To that end, the color of the scene lighting (i.e. the color of the illuminant), usually given in the color space of the image, is optionally transformed into the color space of the light sources 312. This is useful if the light sources operate in a different color space than the image and/or the display. For example, the light sources 312 comprise LEDs capable of rendering different colors depending on their primary colors, where the primary colors of the LEDs are different from the primary colors used to encode the image. The selected color is sent to the light source 312, which produces light in the selected color. Optionally different colors, for example corresponding to lighting conditions in different regions of the screen, are selected, and used to control different light sources around the display and/or elsewhere in the room.

The image analyzer 304 may be based on a gray world assumption. According to this assumption, the scene average is identical to the camera response to a chosen “gray” color value under the scene illuminant. Under the diagonal assumption, the color of white can be estimated from that average. The color of white under the scene illuminant is assumed to be the scene lighting color.

The image analyzer 304 may alternatively be based on illuminant estimation by the maximum of each channel. It estimates the illuminant by the maximum response in each channel, for example the channels R, G, and B if an RGB color space is used.

The image analyzer 304 may alternatively be based on gamut mapping. Particularly, the image analyzer determines a gamut bounded by a convex hull of the colors appearing in (the region of) the image. In the gamut mapping method, the gamut of the image (i.e., the set of colors present in the image) is mapped to a gamut of an imaginary image under predefined illuminants. The best mapping (or mappings) may be used as an estimate of the illuminant. For example, if the image has a yellow illuminant, there will not be much saturated blue colors in the image. This means that the gamut will be smaller towards blue. As it is known in the art how to obtain the illuminant parameters by means of gamut mapping, this will not be elucidated further in this description.

Other methods known in the art of color constancy algorithms include color by correlation and neural network methods. These and other methods are elucidated in Barnard. It will be appreciated by the skilled person that these and other algorithms may be used for identifying illumination parameters of the image or video.

In an embodiment, the color selector is arranged for selecting a chroma and/or a hue of the controlled ambient lighting in dependence on the scene lighting information, and for selecting a luminance of the controlled ambient lighting independently of the scene lighting information. For example, the luminance is kept constant for a more relaxed viewing experience, or the luminance is kept above a predefined minimal value, even if an average luminance of the rendered image is very low.

The system 300 may be arranged for computing the illuminant parameter in real-time just before a rendering of the at least one image on display 314 synchronously with the controlled ambient light effect.

In an embodiment, the input 310 is arranged for receiving the scene lighting information from an external source, for example in the form of metadata accompanying the image or video in a format such as EXIF or MPEG7. The metadata may also be provided in a separate file. The received information is indicative of physical lighting conditions of a scene captured in the at least one image. The color selector selects the color in dependence on the received information, for example it selects a color corresponding to the physical lighting conditions. In another embodiment, the received information is indicative of artificial computer graphics lighting conditions of an artificial computer graphics scene captured in the at least one image. This embodiment is particularly of interest to computer games with ambient lighting.

In an embodiment, input 310 receives an illumination invariant color descriptor (for example as part of MPEG7 data) and the color selector is arranged for selecting the color in dependence on the illumination invariant color descriptor. An example of an illumination invariant color descriptor, known from the MPEG 7 standard, wraps the color descriptors in ISO/IEC 15938-3 that are dominant color, scalable color, color layout, and color structure. One or more color descriptors processed by the illumination invariant method can be included in this descriptor. As a skilled person will recognize, the color selector 302 can compute the scene lighting information by finding a divisor of an illumination invariant color and a color under the scene lighting conditions.

In an embodiment, the system comprises a metadata generator 308. It includes the selected colors in metadata associated with the video or image. For example, the selected color may be included as an attribute using standardized metadata formats such as EXIF or MPEG7. This metadata may be included in an image file or video data stream and stored for later use or broadcasted. In this embodiment, the system does not need, among others, display 314 and/or light controller 316 and/or light source 312.

In an embodiment, the system comprises a light source controller 316. The light source controller 316 controls the ambient light source 312. It converts the selected color received from the color selector 302 into a control signal sent to the light source 312. The light source controller converts the color to a color space that is suitable for directly controlling the light source. For example, if the selected color is given by color selector 302 in a CIELAB color space or in a color space of the display, the color may be converted to a color space based on primaries that the light source is capable of reproducing. Such conversions are known in the art.

The light source 312 may be a light behind the display. It may also be a light source further away from the display. Multiple light sources may be controlled with different colors or with the same color. To this end, the system may comprise more than one light source, light controller, and/or color selector. It is also possible to control a plurality of light sources with a single light source controller. The light sources may be located across the room, for example at least one meter away from the display.

In an embodiment, the system comprises a controlled light source 312. The color of the light produced by light source 312 is selected by color selector 302.

Display 314 is used for rendering the image or video. Light source controller 316 causes the controlled light source to produce light having the selected color synchronously with the rendering of the image. One or more of the controlled light sources 312 may be comprised in apparatuses (or devices) separate from the display. This allows to use the light source further away from the display and from each other. This way, a larger portion of the room may be illuminated in the color based on the scene lighting information.

An authoring tool for creating metadata may have the system 300. The image or video corresponding to the metadata is provided to input 310. Color selector 302 selects the color of the controlled ambient lighting, in dependence on a scene lighting of at least one image captured in the image or video. For example, the image analyzer 304 is used to obtain the scene lighting information. Metadata generator 308 includes an indication of the color in the metadata associated with the image or video.

System 300 may be incorporated in a home entertainment system or a television set. It may also be included in a set top box having for example separate outputs for video output and light source control. Other applications include a personal computer, computer monitor, PDA, or a computer games terminal.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for facilitating accompanying an image or video rendering with a concurrent controlled ambient lighting, comprising a color selector (302) for selecting a color of the controlled ambient lighting in dependence on scene lighting information associated with the image or with at least one image of the video.

2. The system according to claim 1, further comprising:
an input (310) for receiving the image or video;
an image analyzer (304) for computing an illuminant parameter indicative of the scene lighting based on the image or video, wherein the color selector is arranged for selecting the color in dependence on the illuminant parameter.

3. The system according to claim 2, wherein the image analyzer (304) is constructed for computing the illuminant parameter according to at least one of:
a gray world method;
a method of estimating a maximum of each color channel;
a gamut mapping method;
color by correlation; or
a neural network method.

4. The system according to claim 1, wherein the color selector is arranged for selecting a chroma and/or a hue of the controlled ambient lighting in dependence on the scene lighting information.

5. The system according to claim 4, wherein the color selector is arranged for selecting a luminance of the controlled ambient lighting independently of the scene lighting information.

6. The system according to claim 2, wherein the image analyzer is arranged for computing the illuminant parameter in real-time just before a rendering of the at least one image.

7. The system according to claim 1, comprising a metadata generator (308) for including the selected color in metadata associated with the video or image.

8. The system according to claim 1, further comprising an input (310) for receiving the scene lighting information.

9. The system according to claim 8, wherein the scene lighting information is indicative of physical lighting conditions of a scene captured in the at least one image.

10. The system according to claim 8, wherein the scene lighting information is indicative of artificial computer graphics lighting conditions of an artificial computer graphics scene captured in the at least one image.

11. The system according to claim 8, wherein the input (310) is arranged for receiving metadata associated with the video or image, the scene lighting information being incorporated in the metadata, and the input comprising a parser for extracting the scene lighting information from the metadata.

12. The system according to claim 11, wherein the metadata comprises an illumination invariant color descriptor and the color selector is arranged for selecting the color in dependence on the illumination invariant color descriptor.

13. The system according to claim 1, further comprising a light source controller (316) for controlling an ambient light source (312) to produce light having the selected color synchronously with a rendering of the image.

14. The system according to claim 13, further comprising a display (314) for rendering the image.

15. The system according to claim 13, further comprising at least one ambient light source (312) connected to the light source controller (316).

16. The system according to claim 14, further comprising at least one ambient light source (312) connected to the light source controller (316), the ambient light source and the display being comprised in distinct apparatuses.

17. An authoring tool for creating metadata facilitating accompanying an image or video rendering with a concurrent controlled ambient lighting, comprising:
an input (310) for receiving the image or video;
a color selector (302) for selecting a color of the controlled ambient lighting in dependence on scene lighting information associated with the image or with at least one image of the video; and
a metadata generator (308) for including an indication of the color in metadata associated with the image or video.

18. A method of facilitating accompanying an image or video rendering with a concurrent controlled ambient lighting, comprising selecting a color of the controlled ambient lighting in dependence on scene lighting information associated with the image or with at least one image of the video.

19. A computer program product comprising instructions for causing a processor to perform the method according to claim 18.
